(19) United States
(12) Patent Application Publication
(10) Pub. No.: US 2008/0120593 A1
(43) Pub. Date: May 22, 2008

(54) GUI modeling of deep hierarchical data

(76) Inventors: Ido Keren, Hod Hasharon (IL); Rafi Elad, Herzelia (IL)

Correspondence Address: FISH & RICHARDSON, P.C., PO BOX 1022, MINNEAPOLIS, MN, 55440-1022, US

(21) Appl. No.: 11/602,588

(22) Filed: Nov. 21, 2006

(51) Int. Cl. G06F 9/44

(52) U.S. Cl. 717/105

(57) ABSTRACT

This disclosure relates to methods, systems, and software for Graphical User Interface (GUI) modeling of deep hierarchical data in a modeling environment without typically requiring a nearly flat hierarchy. For example, a modeling (or development) environment comprising computer-readable instructions can be operable when executed to present a modeling interface to a developer. The modeling environment identifies a hierarchical data element in response to an indication by the developer via the modeling interface and can automatically generate a model of the identified hierarchical data element. In some cases, the modeled hierarchical data element comprises three or more levels.

### TECHNICAL FIELD

This disclosure relates to computer systems and methods and, more particularly, to methods, systems, and software for GUI modeling of deep hierarchical data in a modeling environment.

### BACKGROUND

Enterprise software systems are generally large and complex. Such systems can require many different components, distributed across many different hardware platforms, possibly in several different geographical locations. In order to design, configure, update or implement an enterprise software system, one is required to understand details of the system at varying levels, depending on his role in designing, managing or implementing the system. For example, a systems administrator may need a high-level technical understanding of how various software modules are installed on physical hardware, such as a server device or a network, and how those software modules interact with other software modules in the system. A person responsible for configuring the software may need a high-level functional understanding of the operations that each functional component provides. An application designer may need a low-level technical understanding of the various software interfaces that portions of the application require or implement. And an application developer may need a detailed understanding of the interfaces and functionality he is implementing in relation to the remainder of the system.

Within a development environment, an application can be developed using modeling systems. In general, these models can specify the types of development objects or components that can be used to build applications, as well as the relationships that can be used to connect those components. In a given modeled architecture, development objects can be organized by any combination of relationships, including hierarchical relationships, grouping relationships, and the like. But typical software modeling systems require that the data set should be “nearly flat,” that is of a hierarchy of 1 to 2 levels deep. In an object-oriented architecture, for example, a defined application can include a combination of various data objects and resources (i.e., development objects). In that example, relationships among the development objects can include a relationship indicating that one data object inherits characteristics from another data object. Another example architecture is the model-view-controller (MVC) architecture. Applications built using the MVC architecture typically include three different types of components—models, which store data such as application data; views, which display information from one or more models; and controllers, which can relate views to models, for example, by receiving events (e.g., events raised by user interaction with one or more views) and invoking corresponding changes in one or more models. When changes occur in a model, the model can update its views. Data binding can be used for data transport between a view and its associated model or controller. For example, a table view (or a table including cells that are organized in rows and columns) can be bound to a corresponding table in a model or controller. Such a binding indicates that the table is to serve as the data source for the table view and, consequently, that the table view is to display data from the table. Continuing with this example, the table view can be replaced by another view, such as a graph view. If the graph view is bound to the same table, the graph view can display the data from the table without requiring any changes to the model or controller. In the MVC architecture, development objects can include models, views, controllers, and components that make up the models, views, and controllers. For example, application data in a model can be an example of a component that is a development object.

To graphically model an application, such that a combination of abstract, graphical representations represent the components of the application and the relationships between those components, a developer typically uses a drawing tool, such as Microsoft Visio, that provides abstract representations and tools for manipulating and/or generating abstract representations. For example, a user of the drawing tool (such as a developer) can choose to use a circle (or any other suitable abstract representation or model) to represent a class (such as a class defined in the C++ or other object-oriented programming language) of an application developed under the object-oriented architecture. The circle that represents a development object can include data from the development object. For example, a name of a class (i.e., data from a development object) can be entered in a text box that is part of the circle, and that name can be displayed in the center of the circle. In addition to drawing tools, the developer can also use other graphical tools to generate graphical representations and models (e.g., Unified Modeling Language (UML) diagrams) from application code, or vice versa.

### SUMMARY

This disclosure relates to methods, systems, and software for Graphical User Interface (GUI) modeling of hierarchical data in a modeling environment. For example, a modeling environment comprising computer-readable instructions is operable when executed to present a modeling interface to a developer. The modeling environment identifies a hierarchical data element in response to a request, a selection, an input, or some other indication by the developer via the modeling interface and can automatically generate a model of the identified hierarchical data element. This generated model may be a complete model or a portion of a more inclusive model. Put another way, the modeling environment may generate a modeling data structure, representing the hierarchical data element, to be incorporated within a preexisting or in-development model of a larger application or interface. In some cases, the modeled hierarchical data element comprises three or more levels.

The foregoing example software—as well as other disclosed processes—may also be computer implementable methods. Moreover, some or all of these aspects may be further included in respective systems or other devices for executing, implementing, or otherwise supporting a modeling environment that can process hierarchical data elements. The details of these and other aspects and embodiments of the disclosure are set forth in the accompanying drawings and the description below. Other features, objects, and advantages of the various embodiments will be apparent from the description and drawings, as well as from the claims.

### DESCRIPTION OF DRAWINGS

FIG. 1 illustrates an example system for graphical user interface (GUI) modeling of deep hierarchical data in a modeling environment in accordance with one embodiment of the present disclosure;

FIG. 2A depicts an example modeling environment in accordance with one embodiment of FIG. 1;

FIG. 2B depicts a simplified process for mapping a model representation to a runtime representation using the example modeling environment of FIG. 2A or some other modeling environment;

FIG. 3 illustrates an example model implementation of a particular hierarchical data element in accordance with one embodiment of the present disclosure;

FIG. 4A illustrates an example interface screen for allowing the developer to provide various information on the modeled hierarchical data element; and

FIG. 4B illustrates an example interface screen presenting deployment of the modeled hierarchical data element.

### DETAILED DESCRIPTION

This disclosure generally describes an example environment 100 for creating, managing, and implementing models of deep hierarchical data using a graphical user interface (GUI) modeling environment 116. Such hierarchical data may include catalogs, folders, items (such as kits), data organized within an XML file, websites, documents, business structures or hierarchical business objects, or another data object or logical structure that has a number of nodes related in some fashion. In other words, the data is logically organized in a hierarchy of many interconnected nodes. Typically, there is a root or parent node with a plurality of children in a number of levels, including deeper hierarchies of three or more levels. The GUI modeling environment 116 may be any development tool, toolkit, application programming interface (API), application, or other framework that allows a developer to develop, configure, and utilize hierarchical data objects that can be more easily modeled during modeling (or during design time) of a particular business application. For example, the model-driven framework or environment may allow the developer to use simple drag-and-drop techniques to develop pattern-based or freestyle user interfaces and define the flow of data between them, including deeper hierarchical data. Such drag and drop techniques may include selecting, inputting, identifying, or some other indication that the developer is interested in a particular object or element. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding; in other words, the modeling environment can be used to create, modify, and examine the model, particularly of hierarchical data.

At a high level, the model is a representation of a software system, part of a software system, or an aspect of a software system. The model can be associated with one or more views. A view of a model represents a subset of the information in the model. For purposes of discussion, the term “model” will be used to refer to both a model or a view of the model. The model can be used in a software development process to describe or specify a software application, or parts or aspects of a software application, for developers implementing or modifying the application. The model specifies the design to a useful level of detail or granularity. In this way, a compliant implementation or deployment of the modeled functionality can conform to the specification represented by the model.

In certain situations, environment 100 bypasses “nearly flat” modeling restrictions (or requirements of the hierarchy being one or two levels) by allowing graphical manipulation of deeper modeled hierarchical data. In these situations, the hierarchical data may be expected to be represented by a root object. Put another way, if the type of the root object is T, it can normally be expected that the type T would have a property that is an array of T. This property can return the child nodes of the given node. For deployment, the developer can configure these components and define the name of this property (treeChildField), as well as the name of the expected label field (treeNodeLabel).

At deployment, a data set can be created for the type T, where the child property is created as the expected array. In certain implementations, the tree has a DataDescriptor that is generally responsible for reading and binding the data to an object model. Each node in the tree is typically identified with a unique identifier. This identifier can be used to select a node and display it, allowing CRUD (Create, Read, Update, and Delete) operations on the tree. In some cases, the server-side may also include an identifier for each node.

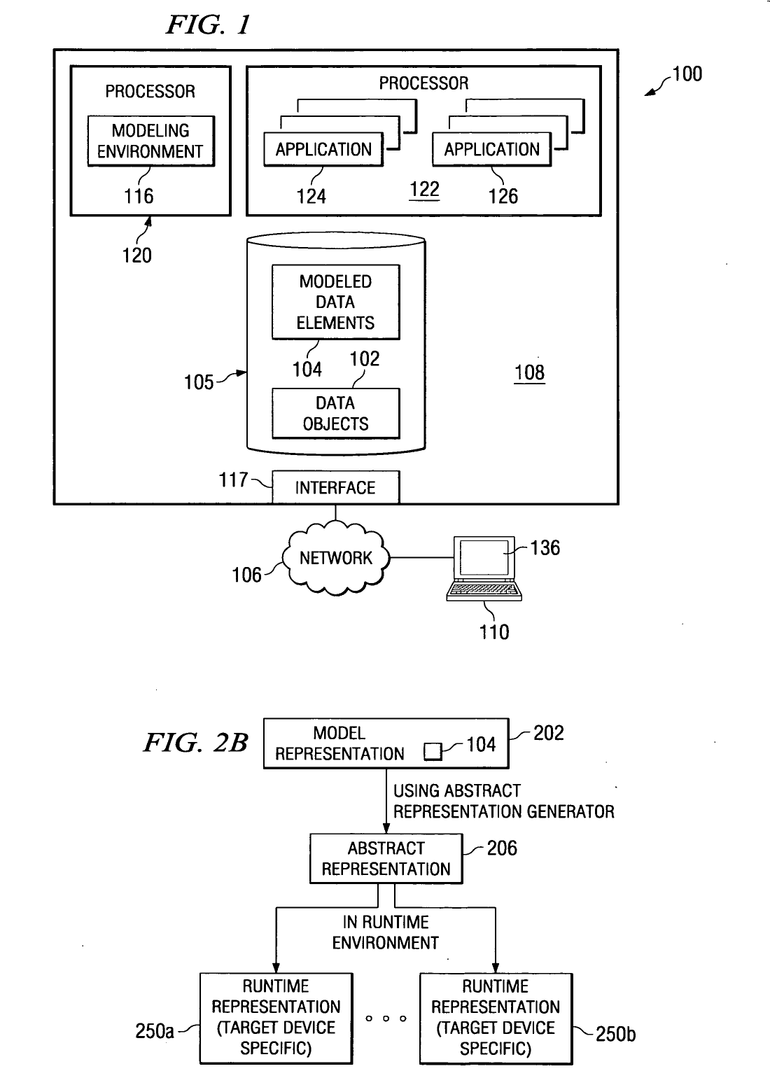

With respect to example FIG. 1, environment 100 is typically a distributed client/server system that spans one or more networks such as 106. As described above, rather than being delivered as packaged software, portions of environment 100 may represent a hosted solution, often for an enterprise or other small business, that may scale cost-effectively and help drive faster adoption. In this case, portions of the hosted solution may be developed by a first entity, while other components are developed by a second entity. Moreover, the processes or activities of the hosted solution may be distributed amongst these entities and their respective components. In some embodiments, environment 100 may be in a dedicated enterprise environment—across a local area network or subnet—or any other suitable environment without departing from the scope of this disclosure.

Turning to the illustrated embodiment, environment 100 includes or is communicably coupled with server 108 and one or more clients 110, at least some of which communicate across network 106. Server 108 comprises an electronic computing device operable to receive, transmit, process and store data associated with environment 100. For example, server 108 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). But, more generally, FIG. 1 provides merely one example of computers that may be used with the disclosure. Each computer is generally intended to encompass any suitable processing device. For example, although FIG. 1 illustrates one server 108 that may be used with the disclosure, environment 100 can be implemented using computers other than servers, as well as a server pool. Indeed, server 108 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 108 may be adapted to execute any operating system including Linux, UNIX, Windows Server, or any other suitable operating system. According to one embodiment, server 108 may also include or be communicably coupled with a web server and/or a mail server.

Server 108 often includes local memory 105. Memory 105 may include any memory or database module and may take the form of volatile or non-volatile memory including, without limitation, magnetic media, optical media, random access memory (RAM), read-only memory (ROM), removable media, or any other suitable local or remote memory component. Illustrated memory 105 includes one or more data objects 102 and, at some point, one or more modeled data elements 104. But memory 105 may also include any other appropriate data such as HTML files or templates, data classes or object interfaces, unillustrated software applications or sub-systems, and others. For example, memory 105 may include pointers or other references to data objects 102 that were published to a location remote from server 108. In this way, a local developer or non-technical business analyst may use a remote hierarchical data element 104 to efficiently supplement the particular data object 102 or software that he is modeling.

Data objects 102 are elements for information storage in object-oriented computing systems. Data objects can describe the characteristics of an item using a series of data fields that, for example, can correspond to described characteristics. Typically, a programmer will predefine standard object classes, referred to in the present specification as object types, that are hardcoded into a set of machine-readable instructions for performing operations. Object types are blueprints for describing individual objects using a defined set of class attributes (or properties). Instantiated objects that are members of such standard object types can be applied in a variety of different data processing activities by users, for example, customers who are largely unaware of the structure of the standard object types. Put another way, the data objects 102 are generally logical structures that can be modeled and then instantiated upon deployment to store particular data. Business objects may be a particular form of data object that a developer can utilize or reference in the front-end of any business or other modeled application. In certain implementations, one or more of the data objects 102 are hierarchical data objects or other elements. These hierarchical data elements can further be recursive elements such that the child nodes are also hierarchical data elements.

Some or all of the data objects 102 and hierarchical data elements may be stored or referenced in a local or remote development repository. For example, this repository may include parameters, pointers, variables, algorithms, instructions rules, files, links, or other data for easily providing information associated with or to facilitate modeling of the particular object. More specifically, each repository may be formatted, stored, or defined as various data structures in extensible Markup Language (XML) documents, text files, Virtual Storage Access Method (VSAM) files, flat files, Btrieve files, comma-separated-value (CSV) files, internal variables, one or more libraries, or any other format capable of storing or presenting the objects and their respective methods in a hierarchical form, such as a tree with multiple nodes. In short, each repository may comprise one table or file or a plurality of tables or files stored on one computer or across a plurality of computers in any appropriate format as described above. Indeed, some or all of the particular repository may be local or remote without departing from the scope of this disclosure and store any type of appropriate data.

According to some embodiments, the developer (or other analyst) may use the model-driven development environment 116 to create pattern-based or freestyle user interfaces using simple drag-and-drop services on the hierarchical data elements 102. Because this development may be model-driven, the developer can typically compose an application using models 104 of data objects 102 without having to write much, if any, code. In some cases, this example modeling environment may provide a personalized, secure interface that helps unify enterprise applications, information, and processes into a coherent, role-based portal experience. Further, the modeling environment may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment may provide a shared set of services for finding, organizing, and accessing unstructured content stored in third-party repositories and content management systems across various networks 106. Classification tools may automate the organization of information, while subject-matter experts and content managers can publish information to distinct user audiences. Regardless of the particular implementation or architecture, this modeling environment may allow the developer to easily model hierarchical data elements 102 using this model-driven approach. As described in more example detail later, the model is deployed, environment 100 may translate the model into the required code for at least one application or web service. This deployed model may then be modified or enhanced as appropriate using the modeling environment 116, which is typically executed on one or more processors.

For example, illustrated server 108 includes processors 120 and 122. The processors 120 and 122 may each be a central processing unit (CPU), a blade, an application specific integrated circuit (ASIC), or a field-programmable gate array (FPGA). Both processor (120 and 122) may execute instructions and manipulate data to perform the operations of server 108. Although FIG. 1 illustrates two processors (120 and 122) in server 108, only one or more than two processors may be used according to particular needs or desires of environment 100. In the illustrated embodiment, processor 120 executes model-driven development tool (or environment) 116 and processor 122 executes modeled application 124 and application 126. At a high level, the modeling environment 116 and applications 124, 126 are operable to receive and/or process requests from developers and/or users and present at least a subset of the results to the particular user via an interface. More specifically, each of applications 124 and 126 may represent any modeled software or other business functionality. For example, modeling environment 116 may be or include a developer studio tool or toolkit providing centralized administration of, development of, publishing of, and access to help objects stored in the infrastructure. In another example, application 124 may represent a first application that is .NET-based, while application 126 may be a hosted web-based solution. In yet another example, each or both the applications 124 or 126 may be a modeled composite application with any number of portions that may be implemented as Enterprise Java Beans (EJBs) or the design-time components may have the ability to generate run-time embodiments into different platforms, such as J2EE, ABAP (Advanced Business Application Programming) objects, or Microsoft's .NET. In a further example, application 124 may merely be a modeled and published web service and application 126 may represent a slightly modified or second instance (say, with different security permissions) of application 124. Further, while illustrated as internal to server 108, one or more processes associated with modeling environment 116, application 124, or application 126 may be stored, referenced, or executed remotely. For example, a portion of an application may be a web service that is remotely called, while another portion of the application may be an interface object bundled for processing at remote client 110. Moreover, modeling environment 116, application 124, or application 126 may each be a child or sub-module of other respective software modules or enterprise applications (not illustrated) without departing from the scope of this disclosure.

Regardless of the particular implementation, “software” may include software, firmware, wired or programmed hardware, or any combination thereof as appropriate. Indeed, each software component may be fully or partially written or described in any appropriate computer language including C, C++, Java, Visual Basic, assembler, Perl, any suitable version of 4GL, as well as others. It will be understood that while the software illustrated in FIG. 1 is shown as a single module that implements the various features and functionality through various objects, methods, or other processes, the software may instead include a number of sub-modules, third party services, components, libraries, and such as appropriate. Conversely, the features and functionality of various components can be combined into single components as appropriate.

Server 108 may also include interface 117 for communicating with other computer systems, such as clients 110, over network 106 in a client-server or other distributed environment. In certain embodiments, server 108 receives data from internal or external senders through interface 117 for storage in memory 105 and/or processing by processor 120 or processor 122. Generally, interface 117 comprises logic encoded in software and/or hardware in a suitable combination and operable to communicate with network 106. More specifically, interface 117 may comprise software supporting one or more communications protocols associated with communications network 106 or hardware operable to communicate physical signals. Interface 117 may allow communications across network 106 via a virtual private network (VPN), SSH (Secure Shell) tunnel, or other secure network connection.

Network 106 facilitates wireless or wireline communication between computer server 108 and any other local or remote computer, such as clients 110. Network 106 may be all or a portion of an enterprise or secured network. In another example, network 106 may be a VPN merely between server 108 and client 110 across wireline or wireless link. Such an example wireless link may be via 802.11a, 802.11b, 802.11g, 802.20, WiMax, and many others. While illustrated as a single or continuous network, network 106 may be logically divided into various sub-nets or virtual networks without departing from the scope of this disclosure, so long as at least a portion of network 106 may facilitate communications between server 108 and at least one client 110. In other words, network 106 encompasses any internal or external network, networks, sub-network, or combination thereof operable to facilitate communications between various computing components in environment 100. Network 106 may communicate, for example, Internet Protocol (IP) packets, Frame Relay frames, Asynchronous Transfer Mode (ATM) cells, voice, video, data, and other suitable information between network addresses. Network 106 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 106 may be a secure network associated with the enterprise and certain local or remote clients 110.

Client 110 is any computing device operable to connect or communicate with server 108 or network 106 using any communication link. At a high level, each client 110 includes or executes at least GUI 136 and comprises an electronic computing device operable to receive, transmit, process and store any appropriate data associated with environment 100. It will be understood that there may be any number of clients 110 communicably coupled to server 108. Further, “client 110,” “developer,” and “user” may be used interchangeably as appropriate without departing from the scope of this disclosure. Moreover, for ease of illustration, each client 110 is described in terms of being used by one user. But this disclosure contemplates that many users may use one computer or that one user may use multiple computers. As used in this disclosure, client 110 is intended to encompass a personal computer, touch screen terminal, workstation, network computer, kiosk, wireless data port, smart phone, personal data assistant (PDA), one or more processors within these or other devices, or any other suitable processing device. For example, client 110 may be a PDA operable to wirelessly connect with external or unsecured network. In another example, client 110 may comprise a laptop that includes an input device, such as a keypad, touch screen, mouse, or other device that can accept information, and an output device that conveys information associated with the operation of server 108 or clients 110, including digital data, visual information, or GUI 136. Both the input device and output device may include fixed or removable storage media such as a magnetic computer disk, CD-ROM, or other suitable media to both receive input from and provide output to users of clients 110 through the display, namely, the client portion of GUI or application interface 136.

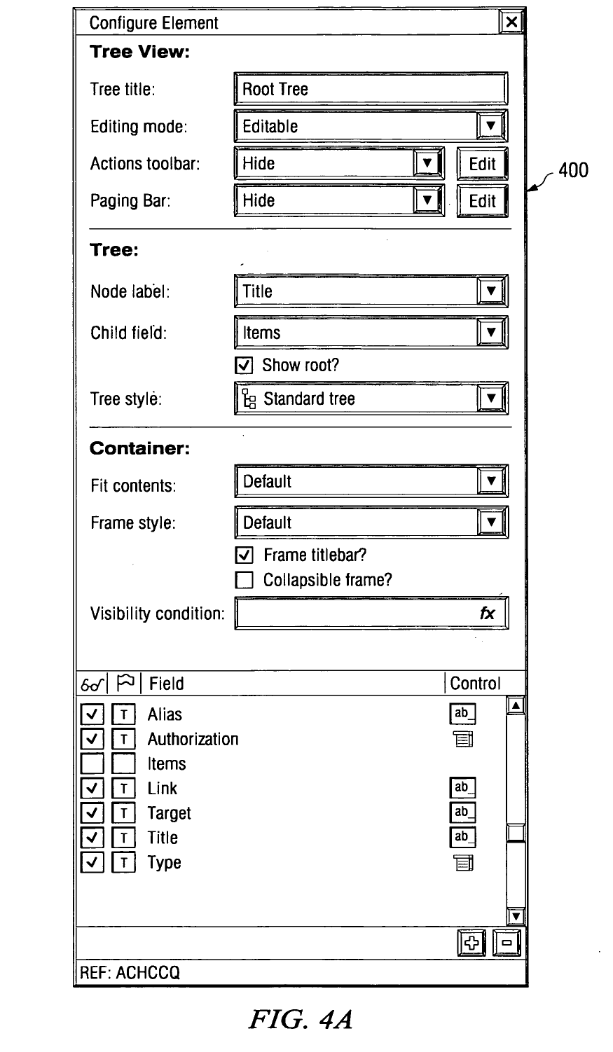

GUI 136 comprises a graphical user interface operable to allow the user of client 110 to interface with at least a portion of environment 100 for any suitable purpose, such as viewing application, modeling, or hierarchical data. Generally, GUI 136 provides the particular user with an efficient and user-friendly presentation of data provided by or communicated within environment 100. More specifically, GUI 136 can include a modeling editor. The modeling editor can be connected with the modeling environment 116 (or other development environment) such that the modeling editor and/or the modeling environment 116 can automatically generate an application model (e.g., a model of an application that is being developed) from a graphical model and/or vice versa. The modeling editor can allow a user to freely choose graphical objects that can represent one or more development objects, or no development objects at all. The modeling editor can support representing different abstraction levels that correspond to a graphical model. For example, this modeling editor can support modeling a detailed view or an abstract view of a graphical model. Typically, the information that is represented in a graphical model can be freely edited. For example, a graphical model can be edited to include user-descriptions or business information that is not part of the development objects and/or relationships among development objects. Changes to development objects and/or relationships among development objects can be automatically reflected in an associated graphical model, and/or vice versa. Accordingly, GUI 136 may comprise a plurality of customizable frames or views having interactive fields, pull-down lists, and buttons operated by the user. For example, GUI 136 is operable to display certain presentation elements, such as help links 134, in a user-friendly form based on what the user, or developer, is trying to accomplish. For example, GUI 136 may present an editor operable to create, manage and/or control a help link 134. In another example, GUI 136 may be a web-based business process application that displays help in a help display area 136, such as illustrated in FIG. 4B. GUI 136 may also present a plurality of portals or dashboards. For example, GUI 136 may display a portal that allows developers or information managers to view, create, and manage data objects 102 or models. GUI 136 is often configurable, supporting a combination of tables and graphs (bar, line, pie, status dials, etc.) and is able to build real-time dashboards. It should be understood that the term “graphical user interface” may be used in the singular or in the plural to describe one or more graphical user interfaces and each of the displays of a particular graphical user interface. Indeed, reference to GUI 136 may indicate a reference to the front-end or a component of any application or software, as well as the particular interface accessible via client 110, as appropriate without departing from the scope of this disclosure. Therefore, GUI 136 contemplates any graphical user interface, such as a generic web browser or touchscreen, that processes information in environment 100 and efficiently presents the results to the user. Server 108 can accept data from client 110 via the web browser (e.g., Microsoft Internet Explorer or Netscape Navigator) and return the appropriate HTML or XML responses to the browser using network 106.

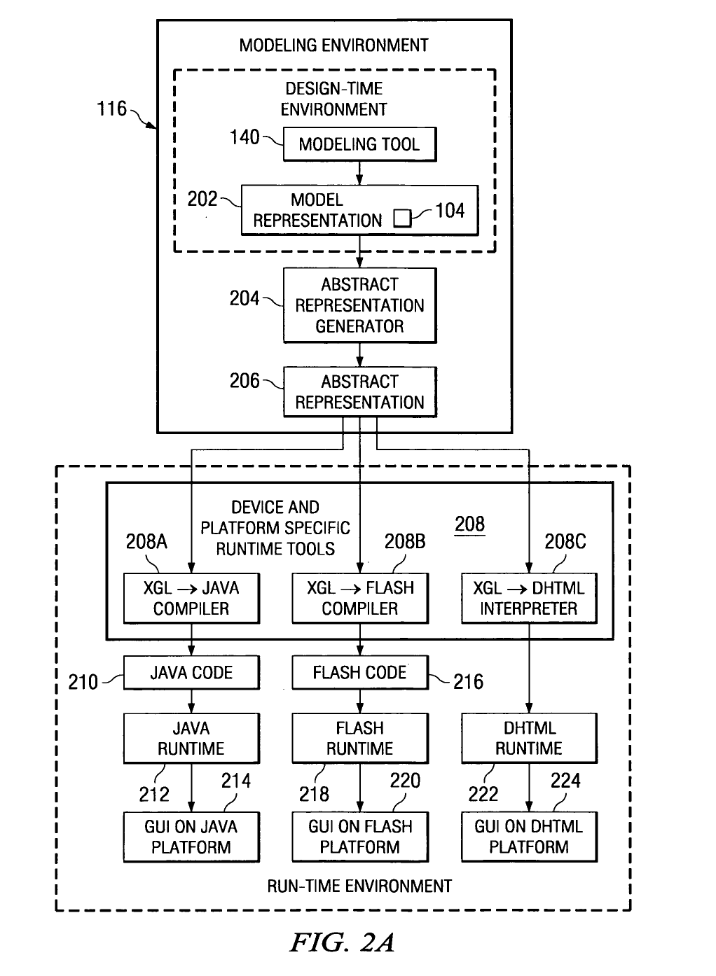

FIG. 2A depicts a more detailed example modeling environment 116 in accordance with one embodiment of the present disclosure. Such a modeling environment 116 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

In certain embodiments, the modeling environment 116 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 2A, modeling tool 140 may be used by a GUI designer or business analyst during the application design phase to create a model representation 202 for a GUI application. It will be understood that modeling environment 116 may include or be compatible with various different modeling tools 140 used to generate model representation 202. This model representation 202 may be a machine-readable representation of an application or a domain specific model. Model representation 202 generally encapsulates various design parameters related to the GUI such as GUI components, dependencies between the GUI components, inputs and outputs, and the like. Put another way, model representation 202 provides a form in which the one or more models can be persisted and transported, and possibly handled by various tools such as code generators, runtime interpreters, analysis and validation tools, merge tools, and the like. In one embodiment, model representation 202 may be a collection of XML documents with a well-formed syntax.

Illustrated modeling environment 116 also includes an abstract representation generator (or XGL generator) 204 operable to generate an abstract representation (for example, XGL representation or XGL-compliant representation) 206 based upon model representation 202. Abstract representation generator 204 takes model representation 202 as input and outputs abstract representation 206 for the model representation. Model representation 202 may include multiple instances of various forms or types depending on the tool/language used for the modeling. In certain cases, these various different model representations may each be mapped to one or more abstract representations 206. Different types of model representations may be transformed or mapped to XGL representations. For each type of model representation, mapping rules may be provided for mapping the model representation to the XGL representation. 206. Different mapping rules may be provided for mapping a model representation to an XGL representation.

This XGL representation 206 that is created from a model representation may then be used for processing in the runtime environment. For example, the XGL representation 206 may be used to generate a machine-executable runtime GUI (or some other runtime representation) that may be executed by a target device. As part of the runtime processing, the XGL representation 206 may be transformed into one or more runtime representations, which may indicate source code in a particular programming language, machine-executable code for a specific runtime environment, executable GUI, and so forth, that may be generated for specific runtime environments and devices. Since the XGL representation 206, rather than the design-time model representation, is used by the runtime environment, the design-time model representation is decoupled from the runtime environment. The XGL representation 206 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 206 generated for a model representation 202 is generally declarative and executable in that it provides a representation of the GUI of model 202 that is not dependent on any device or runtime platform, is not dependent on any programming language, and unambiguously encapsulates execution semantics for the GUI. The execution semantics may include for example, identification of various components of the GUI, interpretation of connections between the various GUI components, information identifying the order of sequencing of events, rules governing dynamic behavior of the GUI, rules governing handling of values by the GUI, and the like. The abstract representation 206 is also not GUI runtime-platform specific. The abstract representation 206 provides a self-contained, closed, and deterministic definition of all aspects of a graphical user interface that is device independent and language independent.

Abstract representation 206 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract generator 204 may be configured to generate abstract representation 206 for models of different types, which may be created using different modeling tools 140. It will be understood that modeling environment 116 may include some, none, or other sub-modules or components as those shown in this example illustration. In other words, modeling environment 116 encompasses the design-time environment (with or without the abstract generator or the various representations), a modeling toolkit (such as 140) linked with a developer's space, or any other appropriate software operable to decouple models created during design-time from the runtime environment. Abstract representation 206 provides an interface between the design time environment and the runtime environment. As shown, this abstract representation 206 may then be used by runtime processing.

As part of runtime processing, modeling environment 116 may include various runtime tools 208 and may generate different types of runtime representations based upon the abstract representation 206. Examples of runtime representations include device or language-dependent (or specific) source code, runtime platform-specific machine-readable code, GUIs for a particular target device, and the like. The runtime tools 208 may include compilers, interpreters, source code generators, and other such tools that are configured to generate runtime platform-specific or target device-specific runtime representations of abstract representation 206. The runtime tool 208 may generate the runtime representation from abstract representation 206 using specific rules that map abstract representation 206 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 206 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 2A, an XGL-to-Java compiler 208a may take abstract representation 206 as input and generate Java code 210 for execution by a target device comprising a Java runtime 212. Java runtime 212 may execute Java code 210 to generate or display a GUI 214 on a Java-platform target device. As another example, an XGL-to-Flash compiler 208b may take abstract representation 206 as input and generate Flash code 216 for execution by a target device comprising a Flash runtime 218. Flash runtime 218 may execute Flash code 216 to generate or display a GUI 220 on a target device comprising a Flash platform. As another example, an XGL-to-DHTML (dynamic HTML) interpreter 208c may take abstract representation 206 as input and generate DHTML statements (instructions) on the fly which are then interpreted by a DHTML runtime 222 to generate or display a GUI 224 on a target device comprising DHTML platform.

It should be apparent that abstract representation 206 may be used to generate GUIs for Extensible Application Markup Language (XAML) or various other runtime platforms and devices. The same model representation 206 may be mapped to various runtime representations and device-specific and runtime platform-specific GUIs. In general, in the runtime environment, machine executable instructions specific to a runtime environment may be generated based upon the abstract representation 206 and executed to generate a GUI in the runtime environment. The same XGL representation may be used to generate machine executable instructions specific to different runtime environments and target devices.

According to certain embodiments, the process of mapping a model representation 202 to an abstract representation 206 and mapping an abstract representation 206 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 206 rather than model representation 202 for runtime processing, the model representation 202 that is created during design-time is decoupled from the runtime environment. Abstract representation 206 thus provides an interface between the modeling environment and the runtime environment. As a result, changes may be made to the design time environment, including changes to model representation 202 or changes that affect model representation 202, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 2B depicts an example process for mapping a model representation 202 to a runtime representation using the example modeling environment 116 of FIG. 2A or some other modeling environment. Model representation 202 may comprise one or more model components 104 and associated properties that describe a hierarchical data object 102. As described above, at least one of these model components 104 is based on or otherwise associated with hierarchical data elements 102. The abstract representation 206 is generated based upon model representation 202. Abstract representation 206 may be generated by the abstract representation generator 204. Abstract representation 206 comprises one or more abstract GUI components and properties associated with the abstract GUI components. As part of generation of abstract representation 206, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 250a, including GUIs for specific runtime environment platform, may be generated from abstract representation 206. A device-dependent runtime representation may be generated for a particular type of target device platform to be used for executing and displaying the GUI encapsulated by the abstract representation. The GUIs generated from abstract representation 206 may comprise various types of GUI elements such as buttons, windows, scrollbars, inputs boxes, etc. Rules may be provided for mapping an abstract representation to a particular runtime representation. Various mapping rules may be provided for different runtime environment platforms.

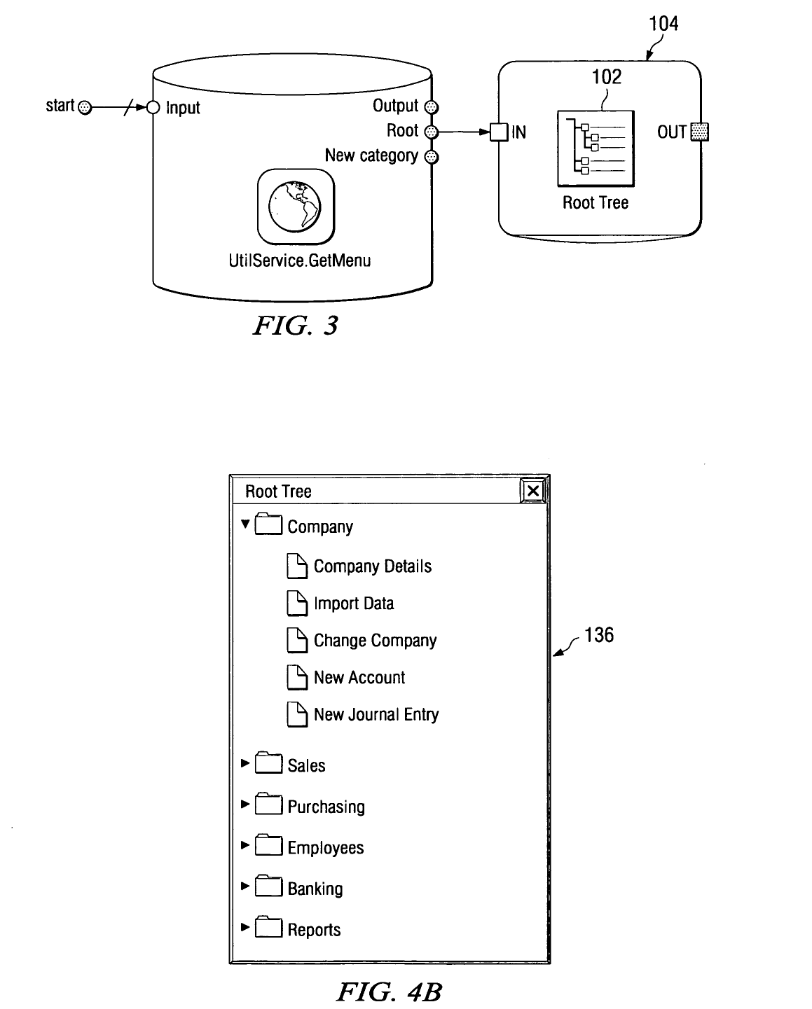

FIG. 3 illustrates an example hierarchical data object or other element 102 embedded, invoked, or otherwise modeled for any suitable modeled application, such as a web service. This example data object 102 represents a “tree” type of hierarchy. In this example, modeling environment 116 calls a GetMenu method to present a menu to a developer. For example, FIG. 4A illustrates a particular menu screen 400 for formatting the metadata, appearance, and layout of the hierarchical data object model 104. In particular, this example configuration interface screen 400 is a control screen that dictates things like hierarchical element title (for example, “tree”), an editing mode (“editable”), whether the deployed element 102 will have an actions toolbar or a paging bar. The interface 400 can also allow the developer to label the node and the child field (i.e., treeNodeLabel and treeChildField), to indicate whether to show the root, and to identify the style of the deployed hierarchy. In some cases, the interface 400 can allow the developer to determine the fit contents, the frame style, the visibility conditions, and whether the deployed object might have a frame titlebar or a collapsible frame. In short, the developer may use this example menu to identify the particular hierarchical data object 102 to be modeled. Of course, the foregoing (illustrated) front-end or menu is for illustration purposes only and may not represent the particular implementation. Returning to FIG. 3, modeling environment 116 may then automatically generate the model 104 and present it to the developer as a graphical object using the modeling editor or other GUI 136.

FIG. 4B illustrates an example deployment of hierarchical data model 104. The example deployment presents various (and a dynamic number of) levels. For example, interface 136 includes a root, then displays a first level including company, sales, purchasing, employees, banking, and reports, and a second level (starting from the “company” node) including company details, import data, change company, new account, and new journal entry child nodes. This illustrated deployment represents an instantiation of the modeled hierarchical data object 102 and includes particular business data. Put another way, the developer identified the particular hierarchical data object 102, generated the model 104, and deployed this model in some application. Modeled hierarchical data elements 104 may be used by several applications that contain business objects 102. For example, two applications in a system may use sales order business objects as part of the functionality. The developer may then graphically model the hierarchical data to the first application. If it wasn't before, the modeled hierarchical data element 104 may become resident on an enterprise-wide repository available to any server or developer with appropriate access or security. A second developer could then use the previously modeled hierarchical data in a second application.

The preceding figures and accompanying description illustrate processes and implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A Graphical User Interface (GUI) modeling environment comprising computer-readable instructions operable when executed to:
present a modeling interface to a developer;
identify a hierarchical data element in response to an indication by the developer via the modeling interface, the hierarchical data element comprising three or more levels; and
automatically generate a model of the identified hierarchical data element.

2. The modeling environment of claim 1, the hierarchical data element comprising one of the following:
a menu;
a catalog;
an item;
a business structure; or
a general ledger object.

3. The modeling environment of claim 1, further operable to identify a type of a root object of the hierarchical data element.

4. The modeling environment of claim 3, further operable to present an interface to the developer such that the developer can define a name for the type of the root object and a name for child objects of the root object.

5. The modeling environment of claim 3, further operable to deploy a dataset for the type of the root object based on the generated model.

6. The modeling environment of claim 5, wherein the hierarchical data element comprises a plurality of children, each child comprising an instance of the hierarchical data element such that a root object of the hierarchical data element is a recursive instance of the hierarchical data element.

7. The modeling environment of claim 5, wherein the modeled hierarchical data element represents a dynamically sized data element at deployment.

8. The modeling environment of claim 1, further operable to embed the generated model of the hierarchical data element into a second model associated with a business application.

9. A computer implemented method comprising:
presenting a graphical user interface (GUI) modeling interface to a developer;
identifying a hierarchical data element in response to an indication by the developer via the modeling interface, the hierarchical data element comprising three or more levels; and
automatically generating a model of the identified hierarchical data element.

10. The method of claim 9, wherein the hierarchical data element comprises one of the following:
a menu;
a catalog;
an item;
a business structure; or
a general ledger object.

11. The method of claim 9, further comprising identifying a type of a root object of the hierarchical data element.

12. The method of claim 11, further comprising presenting an interface to the developer such that the developer can define a name for the type of the root object and a name for child objects of the root object.

13. The computer implemented method of claim 11, further comprising deploying a dataset for the type of the root object based on the generated model.

14. The method of claim 13, the hierarchical data element comprising a plurality of children, each child comprising an instance of the hierarchical data element such that a root object of the hierarchical data element is a recursive instance of the hierarchical data element.

15. The method of claim 13, the modeled hierarchical data element representing a dynamically sized data element at deployment.

16. A modeling system comprising:
memory storing a plurality of hierarchical data elements, at least a subset of the hierarchical data elements comprising three or more levels; and
one or more processors operable to:
present a graphical user interface (GUI) modeling interface to a developer;
identify one of the hierarchical data elements in response to an indication by the developer via the modeling interface; and
automatically generate a model of the identified hierarchical data element.

17. The system of claim 16, wherein the hierarchical data element comprises one of the following:
a menu;
a catalog;
an item;
a business structure; or
a general ledger object.

18. The system of claim 16, the one or more processors operable to identify a type of a root object of the hierarchical data element.

19. The system of claim 18, the one or more processors operable to present an interface to the developer such that the developer can define a name for the type of the root object and a name for child objects of the root object.

20. The system of claim 18, the one or more processors operable to deploy an instantiated dataset for the type of the root object based on the generated model.

21. The system of claim 20, wherein the hierarchical data element comprises a plurality of children, each child comprising an instance of the hierarchical data element such that a root object of the hierarchical data element is a recursive instance of the hierarchical data element.
